(19) United States
(12) Patent Application Publication
(10) Pub. No.: US 2025/0090394 A1
(43) Pub. Date: Mar. 20, 2025

(54) WHEELCHAIR WHEEL LOCK WITH ENHANCED DURABILITY

(71) Applicant: Participant Assistive Products, San Francisco, CA (US)

(72) Inventors: Ryota YAMADA, Corona, CA (US); George James KING, San Francisco, CA (US)

(73) Assignee: Participant Assistive Products, San Francisco, CA (US)

(21) Appl. No.: 18/890,364

(22) Filed: Sep. 19, 2024

Related U.S. Application Data
(60) Provisional application No. 63/583,730, filed on Sep. 19, 2023.

(51) Int. Cl. A61G 5/10

(52) U.S. Cl. CPC A61G 5/1016; A61G 5/1035

(57) ABSTRACT

A wheel lock for a wheelchair is provided. The wheel lock comprises a supporting member configured to attach to a frame of the wheelchair adjacent to a wheel of the wheelchair. The wheel lock also comprises a brake shoe mechanically coupled to the supporting member and configured to be movable between a first directional configuration and a second directional configuration, and a brake pad mechanically coupled to the brake shoe. The wheel lock comprises a lever mechanically coupled to the brake shoe and configured to move the brake shoe between the first directional configuration and the second directional configuration. When the brake shoe is in the first directional configuration, the brake pad does not contact the wheel of the wheelchair. When the brake shoe is in the second directional configuration, the brake pad is configured to mechanically couple to the wheel of the wheelchair to prevent the wheel from rotating.

### CROSS-REFERENCE TO RELATED APPLICATIONS

This application claims the benefit of U.S. Provisional Application No. 63/583,730, filed Sep. 19, 2023, the entire contents of which are incorporated herein by reference.

### FIELD

The present disclosure relates to wheelchairs. In particular, the present disclosure relates to wheel locks for wheelchair wheels.

### BACKGROUND

Effective wheel locks are essential components of functional wheelchairs. A crucial safety feature, wheel locks prevent the wheels of the wheelchair from rotating when the wheelchair user does not wish to move. Many wheelchairs include hand-operated wheel locks positioned within easy reach of the wheelchair user that allow the wheelchair user to control the motion of their wheelchair without relying on assistance from another person and thereby increase the wheelchair user's independence.

Conventional wheel locks may lack user-friendliness: many may be bulky and, when disengaged, fail to provide users with sufficient space to move their hands around the push rims and wheels of the wheelchair. This can cause wheelchair operation to be painful, as users may jam their fingers against disengaged wheel locks while rotating the wheels of the wheelchair. Further, adjusting the position of each wheel lock, which may be necessary to maintain a secure locking force as the tires of the wheelchair age, wear, and/or lose air, may be difficult and time-consuming. According to known techniques, adjusting a wheel lock may involve loosening its attachment to the wheelchair frame, potentially requiring a degree of user skill and experience to make fine, controlled adjustments and/or to prevent loss of an optimum wheel lock position or orientation.

Known wheelchair wheel locks may also include components such as a brake shoe and a lever arranged in a stacked manner that reduces the lock's clamp force and the durability of the components and fasteners. Wheel locks made according to known techniques may not compensate for wear of the brake over time, further reducing clamp force. Reduced clamp force and durability may increase the risk of wheelchair motion while the wheel lock is engaged and in turn the risk of a user falling when transferring to and from the wheelchair.

### SUMMARY

Described herein is a wheel lock for a wheelchair wheel with replaceable and interlocking components to improve durability and user safety. The wheel lock may include a brake pad housed in a brake shoe that may press against the wheelchair wheel when the wheel lock is engaged and swing out of the way when the wheel lock is disengaged. By removably coupling the brake pad to the brake shoe, the wheel lock may enable the brake pad to be replaced as it wears, ensuring the lock applies a reliably safe force to the wheel when engaged, reducing the risk of wheelchair motion when the user is transferring to or from the wheelchair. Further, deformations applied by the wheel when the wheel lock is engaged may be minimized given the nested and interlocked nature of components connected to the brake shoe including a lever, linking member, and attachment component. This in turn may increase the clamping force and durability of the wheel lock relative to known techniques. Placing brake shoe pivot point further from the wheel, and nesting the brake shoe within the lever, may increase the space between the wheel lock and the wheel when the wheel lock is disengaged. This increased space may in turn reduce the risk of hand injury as the user operates the wheelchair in the vicinity of the disengaged wheel lock.

The lever of the wheel lock may be mechanically coupled to the brake shoe and configured to allow the user to manually move the brake shoe between a disengaged position and an engaged position. The engaged position may be approximately parallel to the rotation axis of the wheel while the disengaged position may be approximately orthogonal to the rotation axis. The lever may include a concave portion into which the brake shoe is nested. This, in combination with placement of the pivot point of the brake further from the wheel than that of the lever, may increase the space between the wheel lock in its disengaged position and the wheel. This increased space may allow the wheelchair user a fuller range of motion when operating the wheelchair wheels, thereby decreasing the risk of hand injury.

Removeable and replaceable brake pads enable not only maintenance of the wheel lock's clamp force but customization of the braking surface to match the type of wheels selected by the user, for example an undulating braking surface may more effectively lock tires made of solid rubber. The brake shoe and the lever may be mechanically coupled through the use of a linking member as mentioned above. By interlocking and nesting the brake shoe, linking member, lever, and an attachment component mounted to the wheelchair frame, the wheel lock may be more rigid and resistant to deformations applied the brake pad and brake shoe by the wheel when the wheel lock is engaged, improving the durability of components and associated fasteners and maintaining the lock's clamping force over the course of its life.

To enable controlled adjustments along one or more degrees of freedom, the attachment component of the wheel lock may be mounted in a plurality of ways. For example, the attachment component may be mounted to mounting bar via an adjustable fastener, enabling the lock to moved to a more forward or rearward position, accommodating different wheel positions and brake pad wear. Additionally or alternatively, the attachment component may be mounted to an interface portion with teeth features on both components to enable independent and controlled adjustment of the distance between the wheel lock and the wheelchair frame, for example to accommodate wider or narrower tires. These mounting capabilities may allow users to easily and efficiently make fine adjustments to the wheel lock's position despite the relatively small amount of space available between the wheelchair frame and wheel.

In some embodiments, a wheel lock for a wheelchair is provided, the wheel lock comprising a supporting member configured to attach to a frame of the wheelchair adjacent to a wheel of the wheelchair; a brake shoe mechanically coupled to the supporting member and configured to be movable between a first directional configuration and a second directional configuration; a brake pad mechanically coupled to the brake shoe; and a lever mechanically coupled to the brake shoe and configured to move the brake shoe between the first directional configuration and the second directional configuration; wherein, when the brake shoe is in the first directional configuration, the brake pad does not contact the wheel of the wheelchair, and when the brake shoe is in the second directional configuration, the brake pad is configured to mechanically couple to the wheel of the wheelchair to prevent the wheel from rotating.

In some embodiments, a first side of the lever comprises a concave portion and the brake shoe is at least partially housed in the concave portion. In some embodiments, a first side of the brake shoe comprises a recessed portion and the brake pad is at least partially housed in the recessed portion. In some embodiments, the lever is mechanically coupled to a first attachment point of a linking member, and the brake shoe is mechanically coupled to a second attachment point of the linking member. In some embodiments, the first attachment point and the second attachment point are configured to translate relative to the supporting member when the lever moves the brake shoe between the first directional configuration and the second directional configuration. In some embodiments, the first attachment point of the linking member is at least partially housed in a recess of the lever and the second attachment point of the linking member is at least partially housed in a recess of the brake shoe. In some embodiments the lever is mechanically coupled to the supporting member; and the lever is mechanically coupled to the supporting member at a position that is closer to the wheel of the wheelchair than the position that the brake shoe is mechanically coupled to the supporting member. In some embodiments, when the brake shoe is in the first directional configuration, a length of the brake shoe is parallel to a length of the lever. In some embodiments, when the brake shoe is in the first directional configuration, a length of the brake shoe is orthogonal to a rotation axis of the wheel of the wheelchair; and when the brake shoe is in the second directional configuration, the length of the brake shoe is parallel to the rotation axis of the wheel of the wheelchair. In some embodiments, the brake pad is removable from the brake shoe. In some embodiments, the brake pad is removably coupled to the brake shoe using at least one of a dowel pin, a threaded fastener, or a spring clip. In some embodiments, the surface of the brake pad configured to mechanically couple to the wheel of the wheelchair has an undulating shape. In some embodiments, the brake pad is composed of a metallic material. In some embodiments, the lever is configured to be manually operated.

In some embodiments, the wheel lock further comprises a mounting bar mechanically coupled to the supporting member and configured to attach to the frame of the wheelchair adjacent to the wheel of the wheelchair; wherein the mounting bar comprises a slot along a length of the mounting bar, and a position of the supporting member along a length of the mounting bar slot is configured to be adjustable. In some embodiments, the length of the mounting bar slot, when attached to the frame of the wheelchair, is orthogonal to a rotation axis of the wheel. In some embodiments, the slot is configured to receive a fastener that mechanically couples the supporting member to the mounting bar. In some embodiments, the supporting member is mechanically coupled to the mounting bar by an adjustable fastener. In some embodiments, the adjustable fastener is the only fastener that couples the supporting member to the mounting bar. In some embodiments, the position of the supporting member along the length of the mounting bar slot is adjustable when the adjustable fastener is adjusted by a first amount. In some embodiments, a separation distance between the supporting member and the frame of the wheelchair is adjustable when the adjustable fastener is adjusted by a second amount. In some embodiments, the separation distance is adjustable by at least three inches. In some embodiments, a position adjustment range of the position of the supporting member along the length of the mounting bar slot is between five and 15 inches. In some embodiments, when the brake shoe is in the first directional configuration, a length of the lever is parallel to the length of the mounting bar. In some embodiments, the mounting bar is configured to attach to the frame of the wheelchair adjacent to the wheel of the wheelchair using at least one of a clamping component, a snap-fit joint, or a threaded fastener. In some embodiments, the wheel lock further comprises a clamping component mechanically coupled to the supporting member and configured to attach to the frame of the wheelchair adjacent to the wheel of the wheelchair. In some embodiments, the supporting member is configured to attach to the frame of the wheelchair adjacent to the wheel of the wheelchair using at least one of a snap-fit joint or a threaded fastener.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1 depicts an exemplary wheelchair, according to some embodiments.

FIG. 2A depicts a top view of an exemplary engaged wheel lock installed on a wheelchair, according to some embodiments.

FIG. 2B depicts a top view of an exemplary disengaged wheel lock installed on a wheelchair, according to some embodiments.

FIG. 3A depicts a perspective view of an exemplary engaged wheel lock, according to some embodiments.

FIG. 3B depicts a perspective view of an exemplary disengaged wheel lock, according to some embodiments.

FIG. 4 depicts a perspective view of an exemplary engaged wheel lock, according to some embodiments.

FIG. 5A depicts a top view of an exemplary engaged wheel lock, according to some embodiments.

FIG. 5B depicts a top view of an exemplary disengaged wheel lock, according to some embodiments.

### DETAILED DESCRIPTION

Disclosed herein is a user-friendly wheel lock for wheelchair wheels with interlocking and durable components that minimally obstruct a wheelchair user when the lock is disengaged. The braking component of the wheel lock, or brake shoe, may house a removable brake pad allowing the customization of the clamping surface and the application of a consistent and safe clamping force over the lock's lifecycle. Components of the brake including the brake shoe and a lever used to manually engage or disengage the lock may nest and interlock with one another improving the wheel lock's rigidity and durability when engaged and under load applied by the wheelchair wheel. The pivot point of the brake shoe may be placed further from the wheel and the brake shoe may at least partially nest with the lever, thereby enabling the brake shoe and brake pad to be located further from the user's hands as they operate the wheelchair with the lock in the disengaged position.

The wheel lock may be mounted to the wheelchair frame using mounting components enabling adjustment in one or more directions without requiring complete detachment of the wheel lock from the frame of the wheelchair. The adjustability of the wheel lock may allow it to be used with a wider variety of wheelchairs having differing tire widths and wheel configurations. Further, adjustment mechanisms that enable fine, controlled, and independent adjustments may make users more likely to adjust the position of their wheelchair wheel lock as their wheelchair's wheels and/or brake pads wear, which in turn may reduce the risk of user injury from unintended wheelchair motion.

A wheelchair wheel lock provided herein may include a mounting bar configured to attach to a frame of a wheelchair adjacent to a wheel of the wheelchair, a supporting member mechanically coupled to the mounting bar, and a brake shoe mechanically coupled to the supporting member and configured to be movable between a first directional configuration and a second directional configuration. When the mounting bar is attached to the frame of the wheelchair, a length of the mounting bar may be orthogonal or approximately orthogonal to a rotation axis of the wheel. A position of the supporting member along the length of the mounting bar may be configured to be adjustable. When the brake shoe is in the first directional configuration, a length of the brake pad mechanically coupled to the brake shoe may be orthogonal or approximately orthogonal to the rotation axis of the wheel; when the brake shoe is in the second directional configuration, the length of the brake pad may be parallel or approximately parallel to the rotation axis of the wheel. When the mounting bar is attached to the frame of the wheelchair and the brake shoe is in the second directional configuration, the brake pad may be configured to mechanically couple to the wheel of the wheelchair to prevent the wheel from rotating. A system including the wheel lock and the wheelchair is also described.

A slot may be included along the length of the mounting bar. This slot may be configured to receive a fastener that mechanically couples the supporting member to the mounting bar. The supporting member can be mechanically coupled to the mounting bar by an adjustable fastener. This adjustable fastener may be the only fastener that couples the supporting member to the mounting bar. The position of the supporting member along the length of the mounting bar may be adjustable when the adjustable fastener is adjusted by a first amount. A separation distance between the supporting member and the frame of the wheelchair may be adjustable when the adjustable fastener is adjusted by a second amount. In some embodiments, the separation distance is adjustable by at least 3 inches. A position adjustment range of the position of the supporting member along the length of the mounting bar may be between about 5 inches and about 15 inches.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

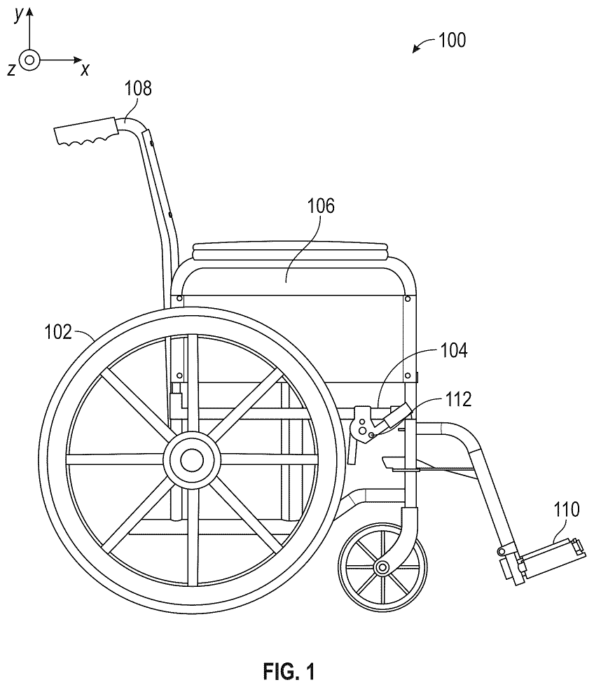

FIG. 1 depicts an exemplary wheelchair 100 that may include a plurality of wheels 102 and a chair 106, both of which may be attached to and supported by a wheelchair frame 104. Wheelchair 100 may include one or more handles 108 to allow wheelchair 100 to be pushed from behind. Additionally, wheelchair 100 may include a footrest 110 configured to support the wheelchair user's feet when the wheelchair is in motion. A wheel lock 112 for wheelchair 100 may be attached to wheelchair frame 104 at a location proximal to a wheel 102.

Propelling wheelchair 100 may involve a user sitting in chair 106 to push wheels 102, for example by moving their hands along tires or hand rims on wheels 102, to cause wheels 102 to rotate. As the user propels wheelchair 100, their hands may frequently pass through the area between wheels 102 and wheelchair frame 104. There may be little space available between wheelchair frame 104 and wheels 102; this space may be further restricted by the presence of wheel lock 112. Thus, to prevent injury to wheelchair users' hands, there is need for wheel locks such as wheel lock 112 to be as compact and unobtrusive as possible when disengaged. The restricted space between wheelchair frame 104 and wheels 102 may also make loosening, adjusting, and/or retightening wheel lock 112 an awkward and time-consuming process. Accordingly, there is need for wheel locks to have adjustment mechanisms that allow minor adjustments to the position of the wheel lock relative to the wheel to be made without completely removing the wheel lock from the wheelchair frame.

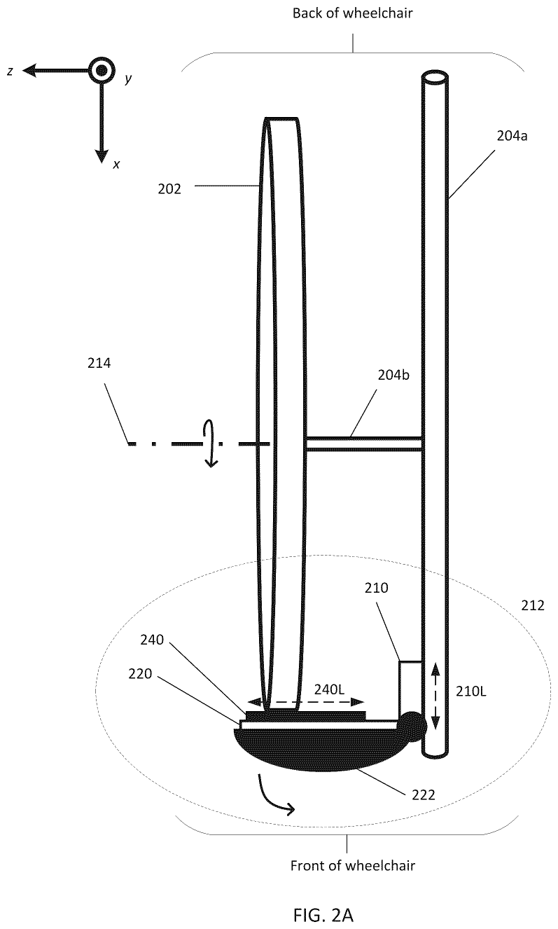

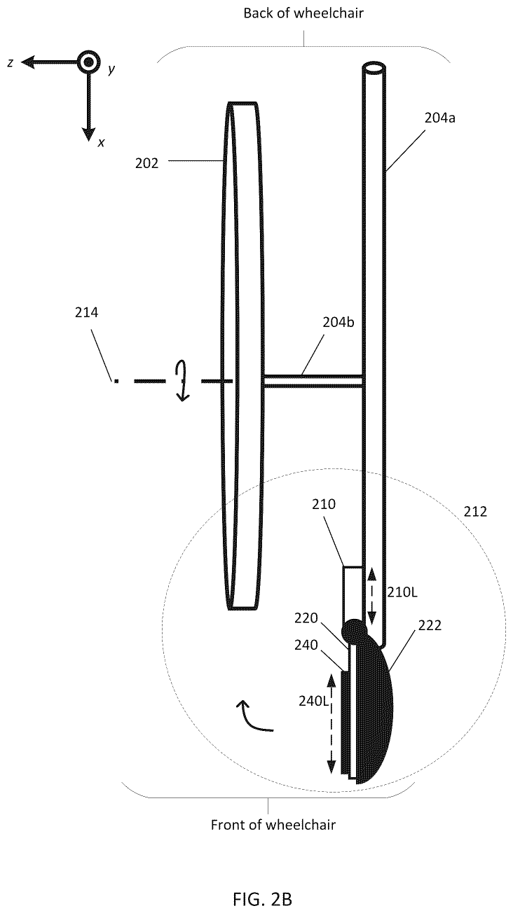

FIGS. 2A and 2B depict top views of an exemplary wheel lock 212 installed on a wheelchair. FIG. 2A depicts wheel lock 212 in an engaged configuration while FIG. 2B depicts it in a disengaged configuration. A wheel 202 of the wheelchair may be mechanically coupled to a first wheelchair frame portion 204a by a second wheelchair frame portion 204b. The wheelchair may be propelled when wheel 202 is caused to rotate about its rotation axis 214, for example when a user pushes on wheel 202.

Wheel lock 212 may include a supporting member 210 that may be configured to attach to wheelchair frame portion 204a at a location proximal to the front of wheel 202. A brake shoe 220 may mechanically couple to supporting member 210 and may include a recess that at least partially houses brake pad 240 with length 240L. A lever 222 may mechanically couple to both supporting member 210 and to brake shoe 220. When wheel lock 212 is engaged, brake pad 240 may come into physical contact with and mechanically couple to wheel 202, and may exert a force on the wheel that is sufficient to prevent it from rotating about rotation axis 214.

Supporting member 210 may be configured to attach to wheelchair frame portion 204a such that a length 210L of supporting member 210 is orthogonal to rotation axis 214 of wheel 202 and is parallel to or approximately parallel to wheelchair frame portion 204a. When wheel lock 212 is engaged, brake pad 240 may be oriented such that length 240L of brake pad 240 is parallel or approximately parallel to rotation axis 214 of wheel 202 and orthogonal or approximately orthogonal to the length 210L of supporting member 210.

To disengage wheel lock 212, the wheelchair user may move lever 222 from an orientation in which length 240L of brake pad 240 is parallel or approximately parallel to rotation axis 214 to an orientation in which length 240L of brake pad 240 is orthogonal or approximately orthogonal to rotation axis 214 and parallel or approximately parallel to length 210L of supporting member 210. A top view of wheel lock 212 in a disengaged position, as described above, is depicted in FIG. 2B.

Lever 222 may have a concave portion into which brake shoe 220 nests. The nesting or interlocking of brake shoe 220 within lever 222 may improve the rigidity of wheel lock 212 given that deformation into or out of the page of FIGS. 2A and 2B is restrained to a degree by lever 222. This deformation may occur when force is applied to the wheelchair while wheel lock 212 is engaged, and brake pad 240 is mechanically coupled to the wheel, for example when a user is transferring to or from the wheelchair. Nesting brake shoe 220 within lever 222 may additionally increase the amount of free space between wheel lock 212 and wheel 202 when wheel lock 212 is disengaged. This in turn may allow a wheelchair user a greater range of motion as they rotate the wheels of the wheelchair for example by moving their hands along tires or hand rims on the wheels.

Thus, disclosed herein is a wheel lock and a system including a wheelchair and a wheel lock that may have the plurality of benefits described above. The system may include one or more wheel locks, for example the system may include two wheel locks, one mounted to a wheelchair frame portion adjacent to each wheel of the wheelchair. In this implementation, a user may use one or both wheel locks to lock one or both wheels of the wheelchair in place.

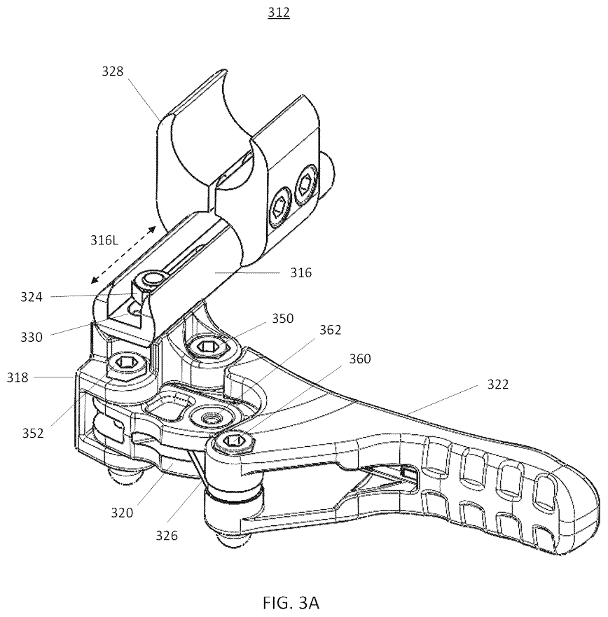

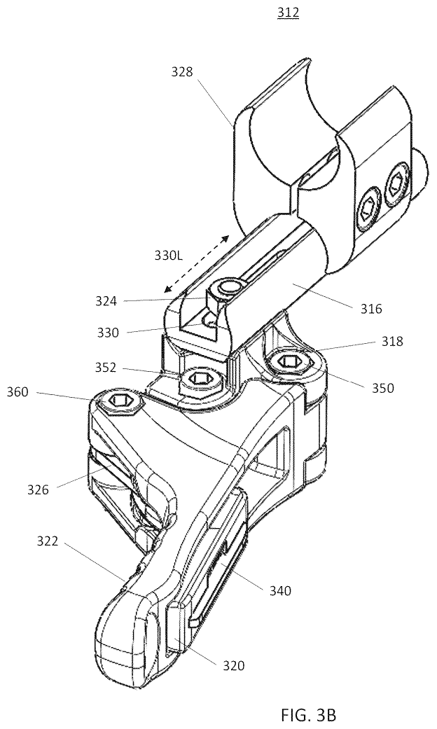

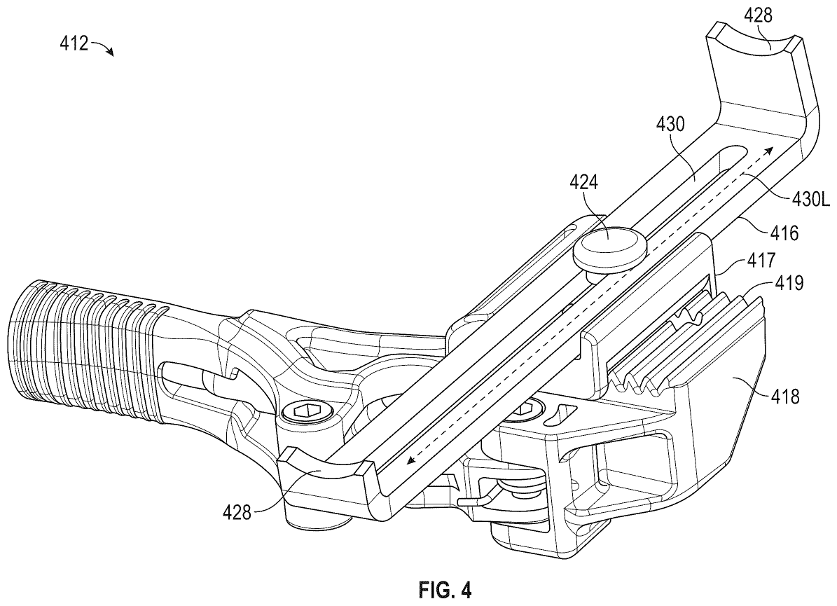

FIGS. 3A, 3B, and 4 depict perspective views of exemplary wheel locks. Wheel lock 312 depicted in FIGS. 3A and 3B may include one or more of the above-described features. Specifically, wheel lock 312 may include brake pad 340 that may be mechanically coupled to and at least partially housed in a recess of brake shoe 320. Brake pad 340 may be positioned such that the surface of the brake pad extends beyond that of brake shoe 320 which in turn may ensure that it is the brake pad 320 that engages with and mechanically couples to the wheel of the wheelchair. Brake pad 340 may be composed of an abrasion-resistant material, for example a metallic material, a plastic material, a ceramic material, and/or a composite thereof. For example, brake pad 340 may be composed of steel, aluminum, titanium, nylon, polypropylene, polyethylene, and/or glass-filled nylon.

Brake pad 340 may be mechanically coupled to brake shoe 320 in a removable manner. For example, a clip such as a spring clip, a threaded fastener, and/or a dowel pin may be used to couple brake pad 340 to brake shoe 320. Each of the aforementioned components may be made of metal and/or plastic, for example a spring clip made of steel, and may interface to brake pad 340 via one or more hole and/or slot features, for example. This removability and thus replaceability may be advantageous as the brake pad surface may wear down over time, especially when wheel lock 312 is engaged to lock the wheel of the wheelchair while the user is transferring to or from the wheelchair. During such times, significant force may be applied to the wheelchair, for example by a user pushing off the wheelchair to move to a different chair or leaning on the wheelchair to sit down. Such a force would propel the wheelchair via rotation of its wheels, were it not for wheel lock 312 holding the wheel in place. This force, and the resulting frictional interaction between wheel lock 312 and the wheel of the wheelchair may result in the above-mentioned wear. By exchanging a worn brake pad 340 for a new one, the clamping force of wheel lock 312 may be restored and the risk of the wheel lock slipping and/or of the wheels of the wheelchair rotating while wheel lock 312 is engaged, potentially resulting in a user injuring themselves, may be reduced. To ensure the brake pad enables a safe clamping force, a user may measure the wear on the brake pad and/or replace the brake pad at a regular interval that may be a function of the frequency with which the user uses the wheelchair and/or locks the wheels of the wheelchair using wheel lock 312.

Brake pad 340 is depicted in FIG. 3B as including a flat surface that engages with and mechanically couples to a wheelchair wheel. Brake pad 340 may additionally or alternatively include an undulating or wavelike surface. A brake pad with a flat surface may produce an optimal locking force for wheelchair wheel tires in the form of a rubber tube inflated with air, while a brake pad with an undulating surface may produce an optimal locking force for wheelchair wheel tires that do not have an air volume and instead are formed of solid rubber. Some users may prefer to use rubber tires inflated with air as they may provide a suspension or cushioning effect while riding in the wheelchair, while other users may prefer to use tires made of solid rubber as they eliminate the puncture and/or air-loss risk associated with use of inflated tires. Mechanically coupling brake pad 340 to brake shoe 320 in a removable manner thus enables brake pad 340 and wheel lock 312 to be customized based on the type of wheel the user prefers.

Brake shoe 320 may be at least partially housed in a concave portion located at the center of lever 322, thereby nesting or interlocking with lever 322. As discussed above, this may increase rigidity and reduce deformation of wheel lock 312 when exposed to forces in the vertical axis of FIGS. 3A and 3B due to the structural reinforcement provided by an interlocking and/or nested configuration. Such forces may include, for example, those applied by the wheel of the wheelchair while wheel lock 312 is engaged, for example while the user is transferring into or out of the wheelchair. An interlocking design provides structural reinforcement because any deformation of brake shoe 320 upward or downward may be resisted by, in addition to the inherent stiffness of brake shoe 320, the stiffness of lever 322: significant deformation of brake shoe 320 may bring the brake shoe into contact with lever 322. This stands in contrast to wheel locks made according to known techniques which may involve a stack of components, one next to another which may reduce contact between components during deformation and/or enabling such contact only during deformation in a certain direction. Such a stacked arrangement may include relatively less support for one or more of the pivot points and the increased deformation and motion of wheel lock components way wear away at the components that form the pivot point, for example pins and/or threaded fasteners. This in turn may further increase play within the joints of the system reducing clamping force and risk of wheelchair motion while the wheel lock is engaged. For example, known wheel locks with a stacked arrangement may fully release while a user is transferring into or out of the wheelchair due to component deformation and wear over time on, for example, holes and pins making up each pivot point.

As discussed above, nesting of brake shoe 320 in lever 322 may additionally allow brake shoe 320 to retract further into lever 322 than it would without nesting of the brake shoe, in turn enabling a larger gap between brake pad 340 and the wheel of the wheelchair when wheel lock 312 is disengaged. This allows a user to more freely pass their hands along the wheels of the wheelchair, for example along the tires and/or hand rims of the wheels, thereby reducing the risk of injury and/or unintentional interaction with disengaged wheel lock 312.

Brake shoe 320 may be mechanically coupled at two points: point 352 mechanically coupling the shoe to supporting member 318 and point 362 mechanically coupling the shoe to linking member 326. Lever 322 may be mechanically coupled at two points: point 350 mechanically coupling the lever to supporting member 318 and point 360 mechanically coupling the lever to linking member 326. Thus, point 362 mechanically coupling the brake shoe 320 to linking member 326 and point 360 mechanically coupling lever 322 to linking member 326 may be at least partially housed in brake shoe 320 and lever 322 respectively. Points 352, 362, 350, and 360 may include a fastener, a pin, and/or a cylindrical component that passes through a hole in corresponding components to enable rotation and/or motion of brake shoe 320, linking member 326, and/or lever 322. For example, point 352 may include a pin or fastener passing through holes in supporting member 318 and/or brake shoe 320, point 362 may include a pin or fastener passing through holes in brake shoe 320 and/or linking member 326, point 350 may include a pin or fastener passing through holes in supporting member 320 and/or lever 322, and point 360 may include a pin or fastener passing through holes in lever 322 and/or linking member 326.

Lever 322 may be ergonomically shaped to enable comfortable and effective manipulation of wheel lock 312 between the engaged and disengaged positions, and may include one or more features to improve a user's grip, for example the one or more indented features shown in FIGS. 3A and 3B and/or the one or more ribbed features shown in FIG. 4.

As shown, brake shoe 320 may nest within a concave portion at the center of lever 322 and/or a recess in supporting member 318, linking member 326 may nest within recesses or slots at the centers of brake shoe 320 and/or lever 322, and lever 322 may nest within a recess at the center of supporting member 318. This nesting may similarly enhance stiffness of wheel lock 312 as discussed above. Here, deformations from forces applied to the wheelchair and transferred to wheel lock 312 while engaged with the wheel of the wheelchair experienced first at brake pad 340 and brake shoe 320 may be reduced through contact with interconnected nested components including lever 322, linking member 326, and supporting member 322. As discussed, this may reduce the risk of slippage of wheel lock 312 and user injury caused by unintended wheelchair motion.

Wheel lock 312 may be attached to a portion of the wheelchair frame such as first wheelchair frame portion 204a shown in FIGS. 2A and 2B using one or more components. For example, as shown in FIGS. 3A and 3B, supporting member 318 may be mechanically coupled to a mounting bar 316 in an adjustable manner. Mounting bar 316 may include a slot 330 that runs along length 330L of mounting bar 316. Supporting member 318 may be mechanically coupled to mounting bar 316 using an adjustable fastener 324 that may be configured to pass through a hole in supporting member 318 and through slot 330. Adjustable fastener 324 may include a threaded fastener such as a screw or bolt that may be fixed in place using a nut. When the fastener or nut is adjusted or loosened, but not to a degree that completely detaches supporting member 318 from mounting bar 316, supporting member 318 may be moved along slot 330 to adjust the position of the supporting member along length 330L of slot 330 in mounting bar 316. Once the user selects a suitable position, the fastener or nut may be readjusted or tightened to secure supporting member 318 to mounting bar 316. Thus, adjustment using mounting bar 316 may take place without removing wheel lock 312 from the wheelchair frame portion.

By mechanically coupling supporting member 318 to mounting bar 316 in an adjustable manner, the position of supporting member 318 along length 330L of slot 330 in mounting bar 316 may be adjusted without requiring mounting bar 316 to be detached from the wheelchair frame portion. Adjusting the position of supporting member 318 may allow users to alter the distance between brake pad 340 and the wheel of the wheelchair when wheel lock 312 is engaged. Making fine adjustments to the distance between brake pad 340 and the wheel, for example by bringing brake pad 340 closer to the wheel, may enable a user to maintain the clamping force of wheel lock 312 as brake pad loses material through use and/or experiences other dimensional changes. With some wheelchairs enabling adjustment of the position of wheels, for example moving them more forward or more rearward of the user, making larger adjustments to the position of the wheel lock 312 may enable a wheelchair user to ensure the wheel lock engages with the wheel irrespective of the wheel's position on the wheelchair.

In one or more examples, the length of slot 330 may be about 5, about 10, about 15, or about 20 inches. In one or more examples, the length of slot 330 may be between 1-10, 10-20, 20-30, 30-40, or 40-50 inches. In one or more examples, the length of slot 330 may be greater than or equal to 5, 6, 7, 8, 9, 10, 11, 12, 13, 14, or 15 inches. In one or more examples, the length of slot 330 may be less than or equal to 5, 6, 7, 8, 9, 10, 11, 12, 13, 14, or 15 inches.

Adjusting the position of adjustable fastener 324 within slot 330 may be controlled by the degree to which adjustable fastener 324 is loosened. For example, if adjustable fastener 324 is loosened only slightly, some friction may remain between the fastener and/or nut and mounting bar 316, enabling small and controlled adjustments. If adjustable fastener 324 is loosened further, larger adjustments may be possible. This mode of adjustment may further enable controlled motions by limiting translational freedom to the single axis of slot 330. Such controlled adjustments may represent an advantage over known techniques which may involve loosening a clamp connecting the wheel lock to the wheelchair frame portion which may enable not only translation long the frame but also rotation of the wheel lock. A user may find that controlling two degrees of freedom simultaneously in the constrained space between the wheelchair wheel and frame difficult, highlighting the benefits of controlled, single degree of freedom adjustments.

A component 328 may mechanically couple mounting bar 316 to the wheelchair frame portion proximate to the wheel, which may be in the shape of a cylindrical or semi-cylindrical tube. Component 328 may include a clamping component in the form of a split clamp with two separate parts as shown, with one or more fasteners (for example the two shown) that may apply a clamping force to mechanically couple the component to the mounting bar and/or to mechanically couple the component to the wheelchair frame portion (not shown). In some implementations, component 328 may be coupled, for example via fasteners, weld points, and/or adhesive, to mounting bar 316 and may use one or more fasteners to couple in turn to the wheelchair frame portion via clamping as described above. In some implementations, in place of clamping, component 328 may instead couple to the wheelchair frame portion using one or more fasteners and/or snap-fit joints.

One or more other configurations may be used to couple wheel lock 312 to the wheelchair portion. In some implementations, mounting bar 316 may be directly coupled to the wheelchair frame portion using one or more fasteners and/or snap-fit joints as discussed below. In other implementations, supporting member 318 may couple directly to a component similar to component 328. For example, a clamping component may be coupled, for example via fasteners, weld points, and/or adhesive, to supporting member 318 and may use one or more fasteners to couple in turn to the wheelchair frame portion via clamping as described above. In some implementations, in place of clamping, component 328 may instead couple to the wheelchair portion using one or more fasteners and/or snap-fit joints. In other implementations supporting member 318 may directly couple to the wheelchair portion using one or more fasteners and/or snap-fit joints.

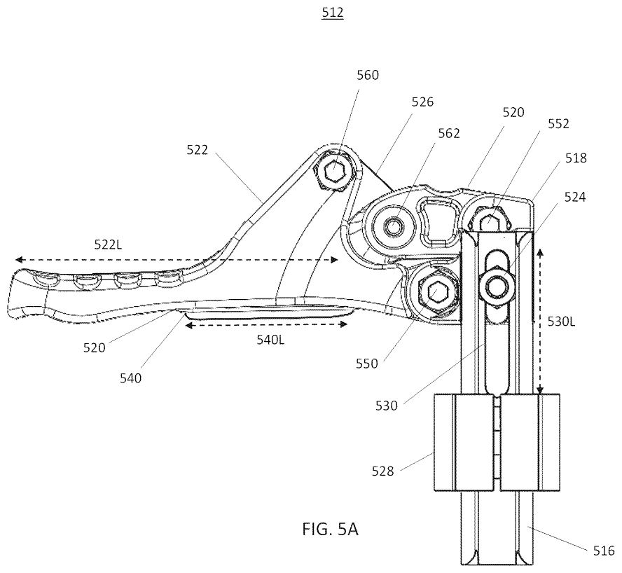

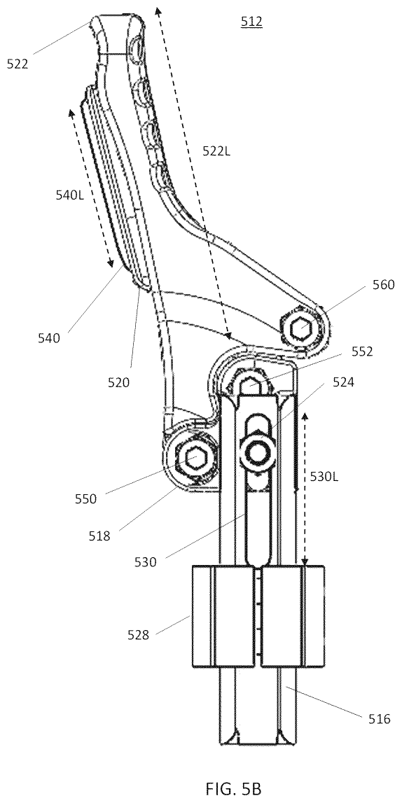

FIG. 4 depicts a perspective view of exemplary engaged wheel lock 412. Wheel lock 412 may include one or more features of wheel lock 212 and 312 presented above and shown in FIGS. 2A-3B and wheel lock 512 presented below and shown in FIGS. 5A and 5B. Wheel lock 412 may include a supporting member 418 that may in turn include a plurality of teeth features 419, and an interface component 417 with a corresponding set of teeth features (not shown) that may be of similar dimension to teeth features 419 to enable supporting member 418 and interface component 417 to interlock. The addition of teeth features to supporting member 418 and interface component 417 may enable adjustment of wheel lock 412 in a controlled manner along an additional translation axis. For example, referring again to FIG. 2A, teeth features may enable adjustment of wheel lock 212 along the z-axis, moving either further from or closer to wheelchair frame portion 204a.

Modification of this separation distance, which may be enabled by adjusting supporting member 418 relative to mounting bar 416 and the wheelchair frame portion, may allow users to change the extent by which wheel lock 412 protrudes from the wheelchair frame portion when wheel lock 412 is engaged. This may allow wheel lock 412 to be used in combination with wheels of varying widths installed at varying gaps relative to the wheelchair frame. For example, if the wheel or tire of the wheelchair is of higher width, a user may increase the separation distance between supporting member 418 and mounting bar 416 so that, when wheel lock 412 is engaged, the brake pad of wheel lock 412 (not shown) is centered on the wheel and the contact area between the brake pad and tire is sufficient to prevent the wheel from rotating. Conversely, if the wheel or tire of the wheelchair is of lower width, a user may decrease the separation distance between supporting member 418 and mounting bar 416 to ensure sufficient alignment and contact between the brake pad and wheel thereby preventing the wheel from rotating when wheel lock 412 is engaged.

As described above in the context of FIGS. 3A and 3B, mounting bar 416 may include a slot 430 of length 430L. Interface component 417 may include a recess to cradle mounting bar 416 and reduce the amount by which it shifts while a user adjusts the position of wheel lock 412. Adjustable fastener 424 may be used to couple supporting member 418 and interface component 417 to mounting bar 416. Adjustable fastener 424 may enable adjustment of supporting member 418 forward and/or rearward along slot 430 to accommodate different wheel locations, based on user preference, and to ensure the brake pad remains in contact with the wheel when the wheel lock is engaged as the brake pad wears over time and/or experiences other shifts in dimension. Adjustable fastener 424 may also be used, as described below to enable adjustment of the separation distance using teeth features 419 and interface component 417 as described above.

Adjustable fastener 424 may pass through holes in supporting member 418, interface component 417, slot 430 of mounting bar 416 and may include a threaded fastener such as a screw or bolt that may be fixed in place using a nut. Mounting bar 416 may include one or more interface elements 428 that may be configured to mechanically couple to the wheelchair frame portion. In some implementations, interface elements 328 may be snap-fit joints configured to connect to the wheelchair frame portion. In other implementations, interface elements 328 may include one or more holes configured to receive fasteners (for example one or more screws or bolts) to facilitate coupling between mounting bar 416 and the wheelchair frame portion.

Adjusting the position of supporting member 418 along mounting bar 416 and/or adjusting the separation distance between supporting member 418 and mounting bar 416 may be accomplished by adjusting or loosening adjustable fastener 424, for example by adjusting the nut of adjustable fastener 424. Adjustable fastener 424 may be configured to be adjusted or loosened by a first amount and a second amount that does not involve completely decoupling mounting bar 416, interface component 417, and/or supporting member 418. When adjustable fastener 424 is adjusted or loosened by the first amount, supporting member 418 may slide along length 430L of slot 430 of mounting bar 416 as described above. When adjustable fastener 424 is adjusted or loosened by the second, greater, amount, teeth feature 419 of supporting member 418 and interface component 417 may separate to a degree sufficient for supporting member 418 to move inward or toward mounting bar 416 and the wheelchair frame portion, and/or outward or away from mounting bar 416 and the wheelchair frame portion. This second adjustment amount is not to a degree that completely detaches supporting member 418 from mounting bar 416. Once a suitable separation distance has been identified, the user may interlock again teeth feature 419 of supporting member 418 and interface component 417 and readjust or tighten adjustable fastener 424. Thus, both types of adjustments may take place without removing wheel lock 412 from the wheelchair frame portion.

In one or more examples, the separation distance between supporting member 418 and mounting bar 416 may be adjusted by about 0.5, about 1, about 1.5, about 2, about 2.5, about 3, about 3.5, about 4, about 4.5, or about 5 inches. In one or more examples, the separation distance between supporting member 418 and mounting bar 416 may be adjusted by at least 1, at least 2, at least 3, at least 4, at least 5, at least 6, at least 7, at least 8, at least 9, or at least 10 inches.

Wheel lock 412 may thus enable a user to controllably and independently adjust the position of the lock along two translational axes. This may involve loosening adjustable fastener 424 by a first amount to adjust position of the lock along slot 430 then by a second amount to adjust the separation distance between the lock and mounting bar 416 and wheelchair frame portion by modifying the position of interface portion 417, before readjusting or tightening adjustable fastener 424 to fix the position. Interlocking teeth features may thus enable a user to first adjust the position of wheel lock 412 along slot 430 before loosening adjustable fastener 424 further to adjust the separation distance between the lock and mounting bar 416, without forcing them to adjust the lock's position along both directions simultaneously. Controlled adjustments along two axes may represent an advantage over known techniques which may involve loosening a clamp connecting the wheel lock to the wheelchair frame portion which may enable not only translation long the frame but also rotation of the wheel lock. Further known techniques may not enable adjustment of the separation distance between the wheel lock and the wheelchair frame portion. Controlling both the position of supporting member 418 along mounting bar 416 and the separation distance between supporting member 418 and the mounting bar 416 and wheelchair frame portion with adjustable fastener 424 may reduce the time and effort needed to change the position of wheel lock 412 particularly given the space constraints that may exist between the wheel and frame of a wheelchair.

FIGS. 5A and 5B depict top views of an exemplary wheel lock 512, with FIG. 5A depicting wheel lock 512 in an engaged configuration and FIG. 5B depicting it in a disengaged configuration. As discussed, brake pad 540 may be mechanically coupled to and nested inside a recess of brake shoe 520. Brake shoe 520 may in turn be nested inside of lever 522. Brake shoe 520 may be mechanically coupled at two points: point 552 mechanically coupling the shoe to supporting member 518 and point 562 mechanically coupling the shoe to linking member 526. Lever 522 may be mechanically coupled at two points: point 550 mechanically coupling the lever to supporting member 518 and point 560 mechanically coupling the lever to linking member 526. Points 552, 562, 550, and 560 may each include a component such as a fastener and/or that passes through a hole in corresponding components to enable rotation and/or motion of brake shoe 520, linking member 526, and/or lever 522. With brake shoe 520 and lever 522 coupled together via linking member 526, brake shoe 520 and brake pad 540 may remain approximately aligned to lever 522 when wheel lock 512 is in both engaged and disengaged positions as shown in FIGS. 5A and 5B respectively. In some implementations, brake shoe 520 and brake pad 540 may be aligned parallel to a length 522L of lever 522 and may be mechanically coupled such that the length 540L of brake pad 540 remains parallel to the length 522L of the lever 522 when wheel lock 312 is both engaged and disengaged.

The point at which brake shoe 522 mechanically couples to supporting member 518, point 550 may be more rearward or closer to the wheel of the wheelchair than the point at which brake shoe 520 mechanically couples to supporting member 518, point 552. Coupling brake shoe 520 at a point that is more forward or further from the wheel of the wheelchair relative to the point at which lever 522 is coupled may, in combination with nesting of brake shoe 520 within lever 522, enable brake shoe to be positioned further from the wheel when wheel lock 512 is in the disengaged state. This in turn may increase the clearance for the user's hands as they operate the wheelchair and reduce risk of injury.

Additionally, each of points 552, 562, 550, and 560 are not all arranged in a line when wheel lock 512 is engaged or disengaged. Arranging pivot points in a line, according to known techniques, may create a position where the wheel lock has little leverage and/or may seize or nearly seize due to said lack of leverage. For example, known wheel locks may require more force to move the lock out of the engaged and/or disengaged position. That is, it may be more difficult for the user to move the lock from either position: if the lock is disengaged, more force may be involved to begin to move it to the engaged position; if the lock is engaged, more force may be involved to begin to move it to the disengaged position. By ensuring the aforementioned points are not all arranged in a line, wheel lock 512 may ensure a clamping force can be applied to and removed from the wheel without the mechanism approaching the point of seizing or jamming.

A user may control the engagement of wheel lock 512 by manually moving lever 522 in an arc such that brake pad 540 may be adjusted from a first directional configuration corresponding to the engaged position shown in FIG. 5A to a second directional configuration corresponding to the disengaged position shown in FIG. 5B. In the first directional configuration, length 550L of brake pad 540 may be parallel or approximately parallel to the length 530L of slot 530 of mounting bar 516, and orthogonal or approximately orthogonal to the rotation axis of the adjacent wheelchair wheel. In the second directional configuration, length 540L of brake pad 540 is orthogonal or approximately orthogonal to the length 530L of slot 530 of mounting bar 516, and parallel or approximately parallel to the rotation axis of the adjacent wheelchair wheel.

The points at which linking member 526 connects to the lever 522 and brake shoe 520, points 560 and 562 respectively, may both move as the user moves lever 522 to/from the engaged and disengaged positions. In this way, linking member 526 may shift in both orientation and position as lever 522 is moved. In contrast, lever 522 and brake shoe 520 may each be coupled at at least one point to supporting member 518, for example at points 550 and 552 respectively. This may allow lever 522 and brake shoe 520, components which experience the highest loading from the wheel of the wheelchair when the wheel lock is engaged, to directly attach to the supporting member which in turn, through one or more components for example including mounting bar 516 and/or clamping component 528, may attach to the wheelchair frame portion. This, in combination with the interlocking nature of brake shoe 520, lever 522, linking member 526, and supporting member 518, may increase the rigidity and reliability of wheel brake 518. Known wheel locks may instead couple the lever and/or brake shoe to a linking member which is in turn coupled to the supporting member. This may increase play in the assembly and risk of the wheel slipping or moving when the wheel lock is engaged.

To ensure wheel lock 512 remains in place and/or to increase the force applied to the wheel of the wheelchair when the wheel lock is engaged, wheel lock 512 may include one or more tension elements, for example one or more torsion springs that may be placed at point 550 and/or point 552, for example. Such torsion springs may provide the necessary tension to enable a user to smoothly move wheel lock 512 into and out of the engaged and disengaged positions.

Length 540L of brake pad 540 may, in one or more examples, be about 5, about 6, about 7, about 8, about 9, about 10, about 11, about 12, about 13, about 14, or about 15 inches. In one or more examples, the length 540L of brake pad 540 may be greater than or equal to 5, 10, 15, or 20 inches. In one or more examples, the length 540L of brake pad 540 may be less than or equal to 5, 10, 15, or 20 inches. Referring to FIG. 4, the length of the brake pad may be combined with adjustability of the separation distance between supporting member 418 and mounting bar 416 to allow the wheel lock to align to the center of wheelchair tires of a variety of widths.

In one or more examples, one or more of brake pad 540, brake shoe 520, lever 522, linking member 526, supporting member 518, interface component 417, mounting bar 516, adjustable fastener 524, and clamping component 528 may be composed of a metallic material, a plastic material, a ceramic material, and/or a composite or combination thereof. For example, each of the aforementioned components may be composed of steel, aluminum, titanium, nylon, polypropylene, polyethylene, and/or glass-filled nylon. One or more fastening components of the wheel lock, including adjustable fastener 524, dowel pins, screws, bolts, and/or clips may include metallic materials, plastic materials, and/or a composite or combination thereof. For example, one or more fastening components may include threaded fasteners and one or more spring clips made of steel.

### EXEMPLARY EMBODIMENTS

Exemplary embodiments of the wheel lock and system described herein include:

Embodiment 1. A wheel lock for a wheelchair, the wheel lock comprising:
a mounting bar configured to attach to a frame of the wheelchair adjacent to a wheel of the wheelchair such that, when attached, a length of the mounting bar is orthogonal to a rotation axis of the wheel;
a supporting member mechanically coupled to the mounting bar, wherein a position of the supporting member along the length of the mounting bar is configured to be adjustable; and
a brake mechanically coupled to the mounting bar and configured to be movable between a first directional configuration and a second directional configuration, wherein, in the first directional configuration, a length of the brake is orthogonal to the rotation axis of the wheel and in the second directional configuration, the length of the brake is parallel to the rotation axis of the wheel.

Embodiment 2. The wheel lock of embodiment 1, wherein, when the mounting bar is attached to the frame of the wheelchair and the brake is in the second directional configuration, the brake is configured to mechanically couple to the wheel of the wheelchair to prevent the wheel from rotating.

Embodiment 3. The wheel lock of embodiment 1, wherein the mounting bar comprises a slot along the length of the mounting bar, wherein the slot is configured to receive a fastener that mechanically couples the supporting member to the mounting bar.

Embodiment 4. The wheel lock of embodiment 1, wherein the supporting member is mechanically coupled to the mounting bar by an adjustable fastener.

Embodiment 5. The wheel lock of embodiment 4, wherein the adjustable fastener is the only fastener that couples the supporting member to the mounting bar.

Embodiment 6. The wheel lock of embodiment 4, wherein the position of the supporting member along the length of the mounting bar is adjustable when the adjustable fastener is adjusted by a first amount.

Embodiment 7. The wheel lock of embodiment 6, wherein a separation distance between the supporting member and the frame of the wheelchair is adjustable when the adjustable fastener is adjusted by a second amount.

Embodiment 8. The wheel lock of embodiment 7, wherein the separation distance is adjustable by at least 3 inches.

Embodiment 9. The wheel lock of embodiment 1, comprising a lever mechanically coupled to the brake and configured to move the brake between the first directional configuration and the second directional configuration.

Embodiment 10. The wheel lock of embodiment 9, wherein a first side of the lever comprises a concave portion and wherein the brake is at least partially housed in the concave portion.

Embodiment 11. The wheel lock of embodiment 9, wherein the lever is configured to be manually operated.

Embodiment 12. The wheel lock of embodiment 9, wherein, when the brake is in the first directional configuration, a length of the lever is parallel to the length of the mounting bar.

Embodiment 13. The wheel lock of embodiment 1, wherein a position adjustment range of the position of the supporting member along the length of the mounting bar is between 5 and 15 inches.

Embodiment 14. A system comprising:
a wheelchair; and
a wheel lock for a wheelchair, the wheel lock comprising:
a mounting bar configured to attach to a frame of the wheelchair adjacent to a wheel of the wheelchair such that, when attached, a length of the mounting bar is orthogonal to a rotation axis of the wheel;
a supporting member mechanically coupled to the mounting bar, wherein a position of the supporting member along the length of the mounting bar is configured to be adjustable; and
a brake mechanically coupled to the mounting bar and configured to be movable between a first directional configuration and a second directional configuration, wherein, in the first directional configuration, a length of the brake is orthogonal to the rotation axis of the wheel and in the second directional configuration, the length of the brake is parallel to the rotation axis of the wheel.

Embodiment 15. The system of embodiment 14, wherein, when the mounting bar is attached to the frame of the wheelchair and the brake is in the second directional configuration, the brake is configured to mechanically couple to the wheel of the wheelchair to prevent the wheel from rotating.

Embodiment 16. The system of embodiment 14, wherein the mounting bar comprises a slot along the length of the mounting bar, wherein the slot is configured to receive a fastener that mechanically couples the supporting member to the mounting bar.

Embodiment 17. The system of embodiment 16, wherein the position of the supporting member along the length of the mounting bar is adjustable when the adjustable fastener is adjusted by a first amount.

Embodiment 18. The system of embodiment 16, wherein a separation distance between the supporting member and the frame of the wheelchair is adjustable when the adjustable fastener is adjusted by a second amount.

Embodiment 19. The system of embodiment 14, wherein the wheel lock comprises a lever mechanically coupled to the brake and configured to move the brake between the first directional configuration and the second directional configuration.

Embodiment 20. The system of embodiment 19, wherein, when the brake is in the first directional configuration, a length of the lever is parallel to the length of the mounting bar.

Any one or more characteristics of any of the embodiments (including claims) described, shown, and/or referenced herein may be combined, in whole or in part, with any one or more characteristics of any one or more other embodiments (including claims) described, shown, and/or referenced herein.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A wheel lock for a wheelchair, the wheel lock comprising:
a supporting member configured to attach to a frame of the wheelchair adjacent to a wheel of the wheelchair;
a brake shoe mechanically coupled to the supporting member and configured to be movable between a first directional configuration and a second directional configuration;
a brake pad mechanically coupled to the brake shoe; and
a lever mechanically coupled to the brake shoe and configured to move the brake shoe between the first directional configuration and the second directional configuration;
wherein, when the brake shoe is in the first directional configuration, the brake pad does not contact the wheel of the wheelchair, and when the brake shoe is in the second directional configuration, the brake pad is configured to mechanically couple to the wheel of the wheelchair to prevent the wheel from rotating.

2. The wheel lock of claim 1, wherein a first side of the lever comprises a concave portion and the brake shoe is at least partially housed in the concave portion.

3. The wheel lock of claim 1, wherein a first side of the brake shoe comprises a recessed portion and the brake pad is at least partially housed in the recessed portion.

4. The wheel lock of claim 1, wherein the lever is mechanically coupled to a first attachment point of a linking member, and the brake shoe is mechanically coupled to a second attachment point of the linking member.

5. The wheel lock of claim 4, wherein the first attachment point and the second attachment point are configured to translate relative to the supporting member when the lever moves the brake shoe between the first directional configuration and the second directional configuration.

6. The wheel lock of claim 4, wherein the first attachment point of the linking member is at least partially housed in a recess of the lever and the second attachment point of the linking member is at least partially housed in a recess of the brake shoe.

7. The wheel lock of claim 1, wherein:
the lever is mechanically coupled to the supporting member; and
the lever is mechanically coupled to the supporting member at a position that is closer to the wheel of the wheelchair than the position that the brake shoe is mechanically coupled to the supporting member.

8. The wheel lock of claim 1, wherein, when the brake shoe is in the first directional configuration, a length of the brake shoe is parallel to a length of the lever.

9. The wheel lock of claim 1, wherein:
when the brake shoe is in the first directional configuration, a length of the brake shoe is orthogonal to a rotation axis of the wheel of the wheelchair; and
when the brake shoe is in the second directional configuration, the length of the brake shoe is parallel to the rotation axis of the wheel of the wheelchair.

10. The wheel lock of claim 1, wherein the brake pad is removable from the brake shoe.

11. The wheel lock of claim 10, wherein the brake pad is removably coupled to the brake shoe using at least one of a dowel pin, a threaded fastener, or a spring clip.

12. The wheel lock of claim 1, wherein the surface of the brake pad configured to mechanically couple to the wheel of the wheelchair has an undulating shape.

13. The wheel lock of claim 1, wherein the brake pad is composed of a metallic material.

14. The wheel lock of claim 1, wherein the lever is configured to be manually operated.

15. The wheel lock of claim 1, wherein the wheel lock further comprises:
a mounting bar mechanically coupled to the supporting member and configured to attach to the frame of the wheelchair adjacent to the wheel of the wheelchair;
wherein the mounting bar comprises a slot along a length of the mounting bar, and a position of the supporting member along a length of the mounting bar slot is configured to be adjustable.

16. The wheel lock of claim 15, wherein the length of the mounting bar slot, when attached to the frame of the wheelchair, is orthogonal to a rotation axis of the wheel.

17. The wheel lock of claim 15, wherein the slot is configured to receive a fastener that mechanically couples the supporting member to the mounting bar.

18. The wheel lock of claim 15, wherein the supporting member is mechanically coupled to the mounting bar by an adjustable fastener.

19. The wheel lock of claim 18, wherein the adjustable fastener is the only fastener that couples the supporting member to the mounting bar.

20. The wheel lock of claim 18, wherein the position of the supporting member along the length of the mounting bar slot is adjustable when the adjustable fastener is adjusted by a first amount.

21. The wheel lock of claim 20, wherein a separation distance between the supporting member and the frame of the wheelchair is adjustable when the adjustable fastener is adjusted by a second amount.

22. The wheel lock of claim 21, wherein the separation distance is adjustable by at least three inches.

23. The wheel lock of claim 15, wherein a position adjustment range of the position of the supporting member along the length of the mounting bar slot is between five and 15 inches.

24. The wheel lock of claim 15, wherein, when the brake shoe is in the first directional configuration, a length of the lever is parallel to the length of the mounting bar.

25. The wheel lock of claim 15, wherein the mounting bar is configured to attach to the frame of the wheelchair adjacent to the wheel of the wheelchair using at least one of a clamping component, a snap-fit joint, or a threaded fastener.

26. The wheel lock of claim 1, wherein the wheel lock further comprises a clamping component mechanically coupled to the supporting member and configured to attach to the frame of the wheelchair adjacent to the wheel of the wheelchair.

27. The wheel lock of claim 1, wherein the supporting member is configured to attach to the frame of the wheelchair adjacent to the wheel of the wheelchair using at least one of a snap-fit joint or a threaded fastener.
